(19) United States
(12) Patent Application Publication
(10) Pub. No.: US 2005/0087485 A1
(43) Pub. Date: Apr. 28, 2005

(54) Fuel pump module

(76) Inventor: Hideaki Takahashi, Yokohama-shi (JP)

Correspondence Address: HAUPTMAN KANESAKA BERNER PATENT AGENTS, SUITE 300, 1700 DIAGONAL RD, ALEXANDRIA, VA, 22314-2848, US

(21) Appl. No.: 10/963,654

(22) Filed: Oct. 14, 2004

(30) Foreign Application Priority Data
Oct. 24, 2003 (JP) 2003-364877

(51) Int. Cl. B01D 1/00; C02F 1/00; F04B 17/00

(52) U.S. Cl. 210/232; 417/364

(57) ABSTRACT

A fuel filter device is disposed in a fuel pump module having a chamber and a fuel pump for supplying fuel in the chamber to an internal combustion engine, so that the fuel filter device filters fuel received inside the chamber on an intake side of the fuel pump. The fuel filter device has a plastic filter body having an internal space communicating with the intake side of the fuel pump and a fuel inflow part at an outer shell part thereof. A constituent member for constituting the fuel pump module is integrated with the fuel body. Accordingly, it is possible to effectively reduce the number of parts of the fuel pump module.

### BACKGROUND OF THE INVENTION AND RELATED ART STATEMENT

The invention relates to a fuel pump module, in particular, a fuel filter device for filtering fuel to be taken into the fuel pump constituting a fuel pump module.

Patent Document 1 has disclosed a mechanism in which a fuel pump is disposed inside a fuel tank for supplying fuel from the fuel tank to an internal combustion engine. Such a fuel pump is disposed inside a chamber. Also, a fuel filter device is attached to an intake port of the fuel pump for filtering fuel received inside the chamber and taken up by the fuel pump before entering the fuel pump. The entire mechanism including these components is called a fuel pump module.

Conventionally, as disclosed in Patent Document 1, the fuel filter device is prepared entirely separately from other members constituting the fuel pump module, and is assembled on the intake port of the fuel pump.

Patent Document 1: Japanese Utility Model (Kokai) No. 03-49367

An object of the invention is to appropriately integrate a fuel filter device constituting a fuel pump module with other members constituting the fuel pump module, thereby effectively reducing the number of parts constituting the fuel pump module.

Further objects and advantages of the invention will be apparent from the following description of the invention.

### SUMMARY OF THE INVENTION

In order to solve the aforementioned problems, according to the invention, a fuel pump module comprises a chamber to be disposed inside a fuel tank for receiving fuel inside the fuel tank; a fuel pump disposed inside the chamber for supplying the fuel inside the chamber to an internal combustion engine with a pressure; and a fuel filter device disposed inside the chamber for filtering the fuel at an intake side of the fuel pump. The fuel filter device includes a filter body formed of a plastic having an internal space communicating with the intake side of the fuel pump and a fuel inflow part in an outer shell part thereof. Further, other constituent member constituting the fuel pump module is integrated with the filter body.

With such a structure, it is possible to effectively reduce the number of parts constituting the fuel pump module, and simplify an assembly process of the fuel pump module.

The other constituent member constituting the fuel pump module may be formed of a lower part of the fuel pump constituting the intake side of the fuel pump integrally formed on an upper part of the filter body. With the integration of the lower part of the fuel pump and the fuel filter device, it is possible to reduce the number of parts of the fuel pump module and eliminate a step of attaching the fuel filter device to the fuel pump.

The other constituent member constituting the fuel pump module may be formed of a side plate part of the chamber integrally connected to a side part of the filter body. With the integration of the filter body and the chamber in the fuel filter device, it is possible to reduce the number of parts of the fuel pump module and support the fuel pump on the chamber with the fuel filter device.

The other constituent member constituting the fuel pump module may be formed of a pump bracket integrally formed on the upper part of the filter body and having a support part for supporting the fuel pump from below and a part for attachment to the chamber. With the integration of the pump bracket for supporting the fuel pump of the chamber and the filter body of the fuel filter device in the fuel pump module, it is possible to reduce the number of parts of the fuel pump module and support the fuel pump in the chamber with the pump bracket integrated with the fuel filter device.

According to the fuel filter device of the invention, the number of parts constituting the fuel pump module including the fuel filter device can be reduced without obstructing a function of the fuel pump module.

### BRIEF DESCRIPTION OF THE DRAWINGS

FIG. 1 is a drawing showing an example of a fuel pump module including a fuel filter device according to the invention;

FIG. 2 is a drawing showing another example of the fuel pump module including the fuel filter device according to the invention;

FIG. 3 is a drawing showing a further example of the fuel pump module including the fuel filter device according to the invention; and

FIG. 4 is a drawing showing an example of a jet pump mechanism.

### DETAILED DESCRIPTION OF PREFERRED EMBODIMENTS

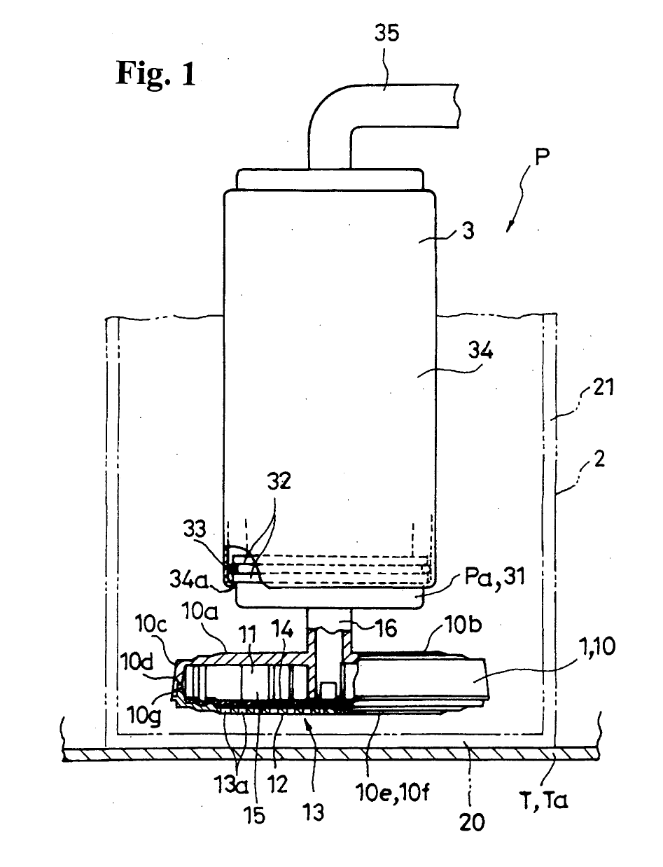

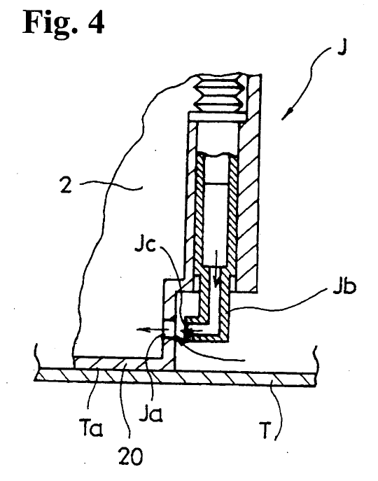

Hereunder, embodiments of the invention will be explained with reference to FIG. 1 through FIG. 4. FIG. 1 through FIG. 3 are structural drawings showing examples of the fuel pump module P including a fuel filter device 1 according to the present invention in sectional views of essential components. FIG. 4 is a structural drawing showing an example of a jet pump mechanism J for allowing a chamber 2 constituting the fuel pump module P to receive fuel. The jet pump mechanism J is provided at a suitable place on a lower part side of the chamber 2.

According to the embodiment, the fuel filter device 1 is a constituent of the fuel pump module P, and filters fuel taken into a fuel pump 3, another constituent of the fuel pump module P. The fuel pump module P includes the fuel filter device 1, the chamber 2, and the fuel pump 3, and is disposed inside a fuel tank T. The fuel filter device 1 and the fuel pump 3 are held inside the chamber 2. The chamber 2 is typically disposed inside the fuel tank T such that an outer surface of a bottom plate part 20 of the chamber 2 contacts an inner surface of a bottom part Ta of the fuel tank T.

The chamber 2 is formed in a container shape with the bottom plate part 20 and a side plate part 21 extending upwardly around the bottom plate part 20, and is constituted so as to receive fuel inside the fuel tank T. The chamber 2 receives fuel therein with typically a jet pump mechanism J shown in FIG. 4. The jet pump mechanism J comprises a through hole Ja formed in the bottom part Ta of the chamber 2, and an excess fuel blow-out pipe Jb having a pipe end Jc oriented toward the through hole Ja. While excess fuel is jetted toward the through hole Ja from the pipe end Jc of the blow-out pipe Jb, fuel inside the fuel tank T is delivered into to the chamber 2 (left side in FIG. 4) together with the excess fuel with a flow of the excess fuel. The excess fuel typically is relieved through a pressure regulator for regulating a pressure of fuel taken up by the fuel pump 3 constituting the fuel pump module P.

The fuel pump 3 takes up fuel received inside the chamber 2, and supplies fuel to an internal combustion engine with a pressure. The fuel taken up by the fuel pump 3 is filtered through a fuel filter provided in a flow path at a blow-out side of the fuel pump 3, and is supplied through a pressure regulator toward the internal combustion engine, specifically, a gasoline injector.

According to the embodiment, the fuel filter device 1 is disposed inside the chamber 2 such that fuel received inside the chamber 2 is filtered on an intake side of the fuel pump 3. As shown in FIG. 1 through FIG. 3, the fuel pump 3 is typically supported inside the chamber 2 such that an intake port 30 faces an inner surface of the bottom plate part 20 of the chamber 2. Also, the fuel filter device 1 is positioned on the intake side of the fuel pump 3 for filtering fuel received inside the chamber 2 and taken into the fuel pump 3 in advance before entering the fuel pump 3.

The fuel filter device 1 has a filter body 10 formed of a plastic and having an internal space 11 communication with the intake side of the fuel pump 3 and a fuel inflow part 13 in an outer shell part 12. As shown in FIG. 1 through FIG. 3, the filter body 10 is formed of an upper structure body 10a and a lower structure body 10e. The upper and lower structure bodies 10a and 10e have plate-shaped base parts 10b and 10f, and an encircling side wall part 10c protruding downwardly and an encircling side wall part 10g protruding upwardly from the base parts 10b and 10f, respectively. The encircling side wall part 10g of the lower structure body 10e is inserted into inside the encircling side wall part 10c of the upper structure body 10a, while a front end of the encircling side wall part 10g of the lower structure body 10e is pushed against a downward-facing step surface 10d formed on the inner surface of the encircling side wall part 10c of the upper structure body 10a. Then, the pushed-in place is welded so that the upper and lower structure bodies 10a and 10e are assembled, and the filter body 10 includes the internal space 11.

On the outer shell part 12 of the filter body 10 defining the internal space 11, that is, both or either one of the upper structure body 10a and the lower structure body 10e, an inflow part 13 of fuel received inside the chamber 2 is formed. In each example shown in FIG. 1 through FIG. 3, the inflow part 13 is formed of plural small holes 13a perforating the base parts 10b and 10f. A filter material 14 is held inside the filter body 10 for covering the inflow part 13 from the internal space 11. In each example shown in FIG. 1 through FIG. 3, the filter material 14 filters fuel coming into the internal space 11 from the inflow part 13. The filter material 14 is typically formed of a single-layered sheet or mat of non-woven cloth or woven mesh, or a laminated body formed of same kind or differing kinds of non-woven cloths or woven meshes in a sheet or mat form, and the like. Also, in each example shown in FIG. 1 through FIG. 3, a space-forming projection 15 is provided on the lower structure body 10e when the inflow part 13 is formed on the upper structure body 10a, or the upper structure body 10a side when the inflow part 13 is formed on the lower structure body 10e. Accordingly, the innermost layer of the filter material 14 is pushed to maintain a state in which the filter material 14 covers the inflow part 13 from inside the filter body 10.

In the fuel filter device 1 of the embodiment, other constituent member Pa constituting the fuel pump module P is integrally provided on the filter body 10. Accordingly, it is possible to effectively reduce the number of parts constituting the fuel pump module P and simplify an assembly process of the fuel pump module P. Specifically, when both or one of the upper structure body 10a and the lower structure body 10e constituting the filter body 10 is formed, the other constituent member Pa is molded together from a plastic material typically with injection molding.

FIG. 1 shows an example in which the other constituent member Pa constituting the fuel pump module P is a lower part 31 of the fuel pump 3 constituting the intake side of the fuel pump 3 integrally formed on an upper part of the filter body 10. With this structure, through the integration of the lower part 31 of the fuel pump and the fuel filter device 1, it is possible to reduce the number of parts of the fuel pump module P and eliminate a step of attaching the fuel filter device 1 to the fuel pump 3.

In the embodiment, a lower end of a connection cylinder part 16 is integrally connected to the upper structure body 10a of the filter body 10, so that an inner portion of the connection cylinder part 16 communicates with the internal space 11 of the filter body 10. The lower part 31 is integrated with an upper end of the connection cylinder part 16. The lower part 31 is formed in a disk shape, and the upper end of the connection cylinder part 16 is integrally connected at a lower surface thereof. The lower part 31 is provided with a channel (not shown) communicating with the inner portion of the connection cylinder part 16 at the upper end thereof. Accordingly, fuel filtered and taken into the internal space 11 of the filter body 10 is taken up inside the fuel pump 3 via the channel.

On an outer perimeter surface of the lower part 31, two encircling projections 32 are formed above and below with a space between. In a state in which a sealing 33 is inserted between the two encircling projections 32, the lower part 31 is inserted into the cylinder body 34 from a lower end 34a of a metal cylinder body 34 constituting an outer shell of the fuel pump 3. In the embodiment, the lower end 34a of the cylinder body 34 is press-fitted against one of the encircling projections 32 of the lower part 31 positioned at a lower side from below, so that the fuel pump 3 is assembled. In the embodiment, fuel is taken up through the connection cylinder part 35 formed on the upper part of the fuel pump 3 and is supplied toward the internal combustion engine with a pressure. In the embodiment, the fuel inflow part 13 is formed at a base part 10f of the lower structure body 10e of the filter body 10.

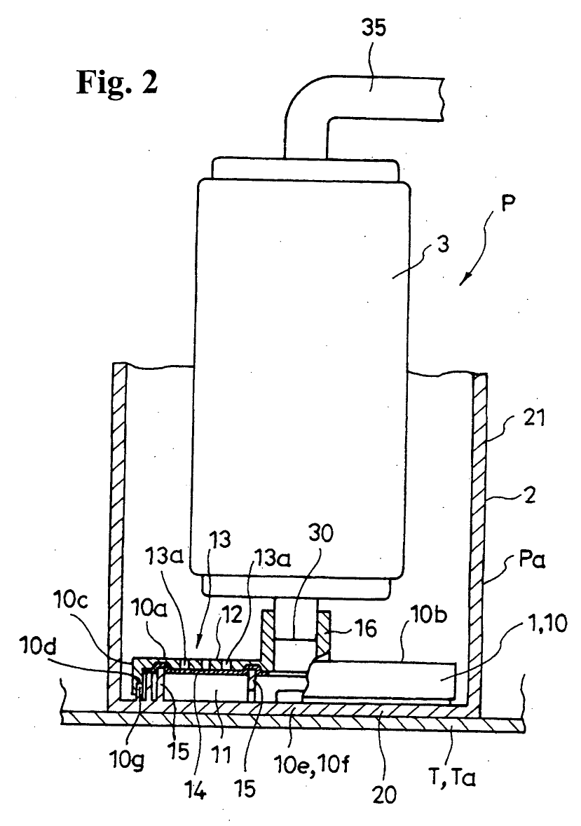

FIG. 2 shows an example in which the other constituent member Pa constituting the fuel pump module P is a side plate part 21 of the chamber 2 integrally connected to a side part of the filter body 10. With this structure, through the integration of the filter body 10 and the chamber 2 in the fuel filter device 1, it is possible to reduce the number of parts of the fuel pump module P and support the fuel pump 3 on the chamber 2 with the fuel filter device 1.

In the embodiment, the lower structure body 10e itself of the filter body 10 becomes the bottom plate part 20 of the chamber 2. That is, a lower end of the side plate part 21 of the chamber 2 is integrally connected to an outer perimeter part of the lower structure body 10e. In the embodiment, the lower structure body 10e of the filter body 10 has the encircling side wall part 10g at inside a connection portion of the lower end of the side plate part 21 of the chamber 2. In the embodiment, the fuel inflow part 13 is formed at the base part 10b of the upper structure body 10a of the filter body 10. The lower end of the connection cylinder part 16 is integrally connected to the upper structure body 10a, and the inner portion of the connection cylinder part 16 communicates with the internal space 11 of the filter body 10. The intake port 30 of the fuel pump 3 with a cylindrical shape is inserted into the connection cylinder part 16, so that fuel in the filter body 10 is taken up into the fuel pump 3. In the embodiment, fuel is sent toward an internal combustion engine through the connection cylinder part 35 formed on the upper part of the fuel pump 3 with a pressure.

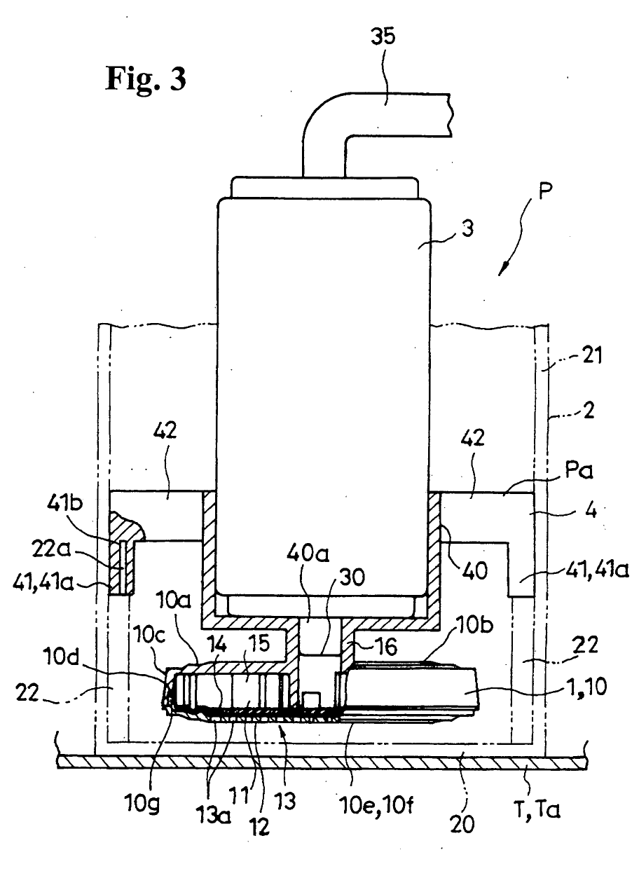

FIG. 3 shows an example in which the other constituent member Pa constituting the fuel pump module P is a pump bracket 4 integrally formed on the upper part of the filter body 10 and having a support part 40 for supporting the fuel pump 3 from below and parts 41 for attachment to the chamber 2.

With this structure, through the integration of the pump bracket 4 for supporting the fuel pump 3 in the chamber 2 and the filter body 10 in the fuel filter device 1 in the fuel pump module P, it is possible to reduce the number of parts of the fuel pump module P and support the fuel pump 3 in the chamber 2 with the pump bracket 4 integrated with the fuel filter device 1.

In the embodiment, the support part 40 of the pump bracket 4 is formed in a cylindrical shape having an open cylinder upper end, and is provided with a connection hole 40a in a bottom part thereof for inserting the cylindrical intake port 30 of the fuel pump 3 from above. The lower end of the connection cylinder part 16 is integrally connected to the upper structure body 10a of the filter body 10 and communicates with the internal space 11 of the filter body 10. The upper end of the connection cylinder part 16 is connected to the connection hole 40a, so that the support part 40 and the filter body 10 are integrated. An inner diameter of the support part 40 is about equal to an outer diameter of the fuel pump 3. In the embodiment, the lower part of the fuel pump 3 is inserted into the support part 40 from above, and the intake port 30 of the fuel pump 3 is inserted into the connection hole 40a. Accordingly, the support part 40 and the lower part of the fuel pump 3 are assembled without rattling.

Each of the parts 41 for attachment to the chamber 2 is formed on the other end of an arm body 42 protruding sideward with one end integrally connected to the outer surface part of the support part 40. In the embodiment, a projection 41a for assembly is formed, and projects downwardly with an upper end integrally connected to the other end of the arm body 42. A projecting piece 22a formed on a projecting end of a boss part 22 formed on the inner wall of the side plate part 21 of the chamber 2 is inserted from below into an insertion hole 41b formed in the projection 41a for assembly, so that the parts for attachment 41 are supported on the boss parts 22. In the embodiment, the parts for attachment 41 are formed on the left and right sides with the support part 40 in between.

In the embodiment, the fuel inflow part 13 is formed on the base part 10f of the lower structure body 10e of the filter body 10. Also, fuel taken up by the fuel pump 3 is sent toward an internal combustion engine through the connection cylinder part 35 formed on the upper part of the fuel pump 3 with a pressure.

The disclosure of Japanese Patent Application No. 2003-364877, filed on Oct. 24, 2003, is incorporated in the application.

While the invention has been explained with reference to the specific embodiments of the invention, the explanation is illustrative and the invention is limited only by the appended claims.

1. A fuel pump module, comprising:
a chamber device to be disposed in a fuel tank for receiving fuel from a fuel tank and having a chamber therein,
a fuel pump disposed in the chamber for supplying the fuel to an internal combustion engine, and
a fuel filter device disposed in the chamber and attached to the fuel pump for filtering the fuel at an intake side of the fuel pump, said fuel filter device including a filter body formed of plastic and having an internal space communicating with the intake side of the fuel pump, an outer shell part, and a fuel inflow part formed in the outer shell part, said filter body being integrated with at least a part of a member forming the chamber device and the fuel pump.

2. A fuel pump module according to claim 1, wherein said fuel pump includes a lower portion for forming the intake side of the fuel pump, said lower portion being integrally formed with an upper part of the filter body.

3. A fuel pump module according to claim 2, wherein said fuel filter device includes a filter disposed adjacent the outer shell part, and said filter body includes a lower part and an upper part assembled with the lower part, at least one of the lower part and the upper part forming the outer shell part.

4. A fuel pump module according to claim 1, wherein said chamber device includes a plate integrated with the filter body.

5. A fuel pump module according to claim 4, wherein said outer shell part of the filter body is attached to a bottom plate of the chamber to form the internal space therebetween

6. A fuel pump module according to claim 1, further comprising a pump bracket having a support part for supporting the fuel pump from below and an attachment part for attaching the fuel pump to the chamber device, said filter body being integrated with the pump bracket at an upper part thereof.
